(19) United States
(12) Patent Application Publication
(10) Pub. No.: US 2006/0130043 A1
(43) Pub. Date: Jun. 15, 2006

(54) Method and apparatus to upgrade software of an apparatus having a plurality of microprocessors

(76) Inventors: Yong-jun Park, Seoul (KR); Byung-soo Kim, Seoul (KR)

Correspondence Address: STANZIONE & KIM, LLP, 919 18TH STREET, N.W., SUITE 440, WASHINGTON, DC, 20006, US

(21) Appl. No.: 11/169,582

(22) Filed: Jun. 30, 2005

(30) Foreign Application Priority Data
Nov. 17, 2004 (KR) 2004-94270

(51) Int. Cl. G06F 9/44

(52) U.S. Cl. 717/168

(57) ABSTRACT

A method and apparatus to upgrade software of an apparatus having a plurality of microprocessors. The method includes: each of the plurality of microprocessors transmitting their identification information and information regarding current software externally to an upgrade device which is connected to the target apparatus via a common external interface; receiving identification information of the microprocessor to be upgraded from the upgrade device; preparing the microprocessor to be upgraded for communication with the upgrade device while setting the rest of the microprocessors into a standby mode; and upgrading software of the microprocessor to be upgraded by communicating with the upgrade device.

### CROSS-REFERENCE TO RELATED APPLICATIONS

This application claims the priority of Korean Patent Application No. 2004-94270, filed on Nov. 17, 2004, in the Korean Intellectual Property Office, the disclosure of which is incorporated herein in its entirety by reference.

### BACKGROUND OF THE INVENTION

1. Field of the Invention

The present general inventive concept relates to upgrading of software, and more particularly, to a method and apparatus to upgrade software of an apparatus having a plurality of microprocessors.

2. Description of the Related Art

Various hardware and software components are installed in a single electronic device so that the electronic device can perform a range of functions. Additionally, plural microprocessors are required to be mounted in a single electronic device since there is a limit to the number of operations that can be performed with a single microprocessor.

When upgraded software is developed, the software for a microprocessor included in an electronic device must also be upgraded. To accommodate the upgrading software, an external interface port of the electronic device is connected to a computer in which an application for upgrading software is mounted. The microprocessor is initialized after current flows thereto, and the upgraded software is transmitted to the microprocessor through communication between the computer and the microprocessor.

Conventionally, when an electronic device has a plurality of microprocessors, software must be upgraded separately for each of the microprocessors by providing a separate external interface for each of the microprocessors.

FIG. 1 is a block diagram illustrating a conventional method of upgrading software for an electronic device 200 including a plurality of microprocessors. Referring to FIG. 1, the electronic device 200 includes first, second, . . . , N^{th} microprocessors 240, 250, . . . , 260, and first, second, . . . , N^{th} external interfaces 210, 220, . . . , 230. A personal computer (PC) 10, in which an application for software upgrading is mounted, upgrades software of the first microprocessor 240 via the first external interface 210, upgrades software of the second microprocessor 250 via the second external interface 220, . . . , upgrades software of the N^{th} microprocessor 260 via the N^{th} external interface 230.

According to the conventional method described above, the number of external interfaces required for upgrading microprocessors increases proportionally as the number of microprocessors mounted in an electronic device increases. As a result, the cost and size of the electronic device increases as the number of microprocessors within the electronic device increases. In addition, when upgrading all of the plurality of microprocessors within the electronic device, a large amount of time is consumed since a connecting device connected to a computer and used for upgrading the software of each of the microprocessors needs to be sequentially connected to each of the external interfaces of the microprocessors. Furthermore, errors and other problems can occur, such as connecting the computer to a wrong external interface in the attempt to update the software for a microprocessor, if plural microprocessors of the same type are included in an electronic device.

### SUMMARY OF THE INVENTION

The present general inventive concept provides an apparatus having a plurality of microprocessors with a simple hardware structure that can quickly upgrade the software of each of the plurality of microprocessors and reduce errors that frequently occur during the upgrading.

The present general inventive concept also provides a method of upgrading software that can be used to quickly upgrade the software of a plurality of microprocessors included in an apparatus, while reducing the occurrence of errors that can take place during the upgrading.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing an apparatus that upgrades software by communicating with an upgrade device, including: an external interface which communicates with the upgrade device; and a plurality of microprocessors, each storing identification information and information regarding current software. Each of the microprocessors can transmit the identification information and the information regarding the current software to the upgrade device via the external interface. The microprocessor among the plurality of microprocessors that has identification information corresponding to identification information received from the upgrade device is determined to be the microprocessor to be upgraded, and prepares to communicate with the upgrade device through the external interface while the rest of the microprocessors are set in a standby mode, and then the microprocessor to be upgraded upgrades its software by communicating with the upgrade device.

The foregoing and/or other aspects of the present general inventive concept are also achieved by providing a method of upgrading software for a plurality of microprocessors associated with an electronic device, the method including: transmitting from each of the plurality of microprocessors identification information and information regarding current software thereof to an upgrade device which is connected externally to the electronic device; receiving at the electronic device identification information of a microprocessor to be upgraded from the upgrade device; preparing the microprocessor to be upgraded for communication with the upgrade device while setting the rest of the microprocessors in a standby mode; and upgrading software of the microprocessor to be upgraded by providing communication between the microprocessor to be upgraded and the upgrade device.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a conventional method of upgrading software of a microprocessor;

FIG. 2 is a block diagram of an apparatus having a plurality of microprocessors according to an embodiment of the present general inventive concept;

FIG. 3 is a block diagram of a host microprocessor and slave microprocessors according to an embodiment of the present general inventive concept;

FIG. 4 is a flow chart illustrating a method of upgrading software of a plurality of microprocessors according to an embodiment of the present general inventive concept; and

FIG. 5 is a flow chart illustrating a process of upgrading software of a microprocessor to be upgraded included in the method illustrated in FIG. 4.

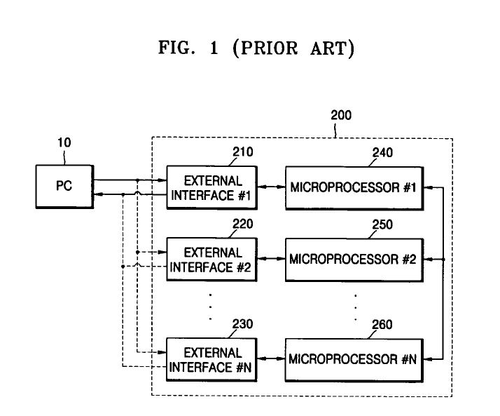

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

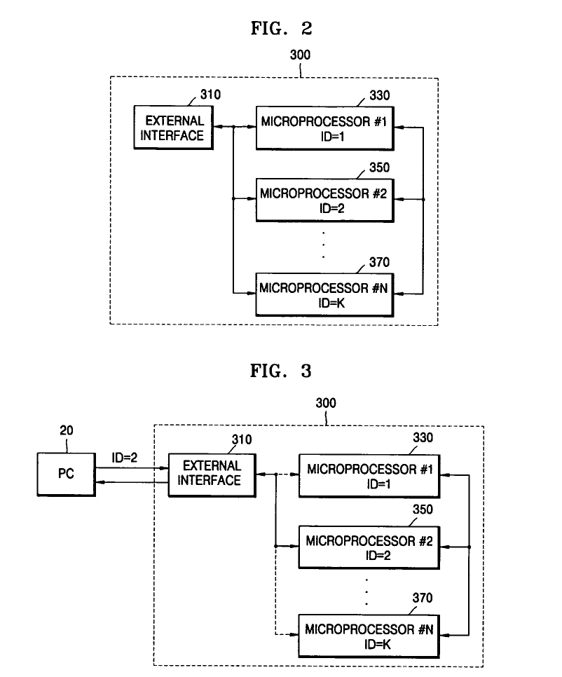

FIG. 2 is a block diagram of an apparatus 300 having a plurality of microprocessors according to an embodiment of the present general inventive concept. Referring to FIG. 2, the apparatus 300 includes an external interface 310, and first, second, . . . , N^{th} microprocessors 330, 350, . . . , 370.

The apparatus 300 requires only one external interface 310 to connect an upgrade device with each of the first, second, . . . , N^{th} microprocessors 330, 350, . . . , 370. The upgrade device is a separate device having an application to upgrade software of microprocessors and includes software to be used to upgrade each of the plurality of microprocessors. The upgrade device can be a computer, such as a desktop computer or a notebook computer. Unique identification information is allocated to the first, second, . . . , N^{th} microprocessors 330, 350, . . . , 370, and is stored in an internal memory (not shown). Using the application to upgrade software, the upgrade device can select one of the plurality of microprocessors. The selected microprocessor then prepares to communicate with the upgrade device via the external interface while the rest of the microprocessors are set in standby mode. In an alternative embodiment of the present inventive concept, one of the first, second, . . . , N^{th} microprocessors 330, 350, . . . , 370 selected by the upgrade device can be designated as a host microprocessor while the rest of the microprocessors are designated as slave microprocessors via intercommunication with the upgrade device. For example, FIG. 3 illustrates where the second microprocessor 350, selected by a personal computer (PC) 20 which is acting as the upgrade device, is a host microprocessor while the first, . . . , N^{th} microprocessors 330, . . . , 370 are slave microprocessors.

A method of upgrading software of the first, second, . . . , N^{th} microprocessors 330, 350, . . . , 370 will be described in more detail based on the structure of the apparatus 300 including the first, second, . . . , N^{th} microprocessors 330, 350, . . . , 370.

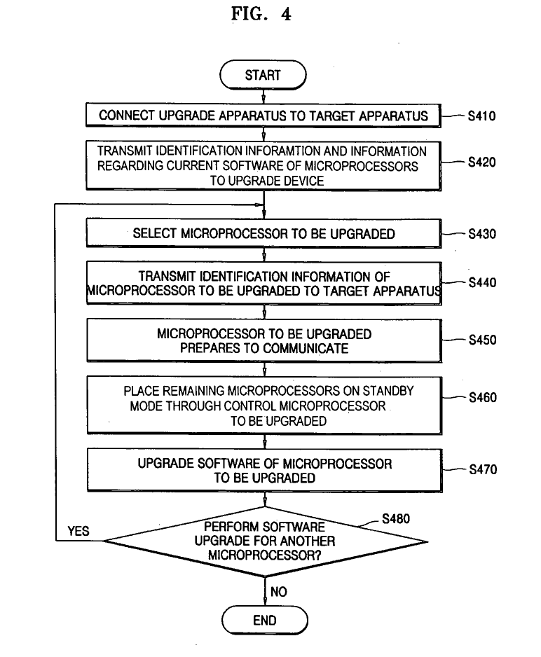

FIG. 4 is a flow chart illustrating a method of upgrading the software of the first, second, . . . , N^{th} microprocessors 330, 350, . . . , 370 according to an embodiment of the present general inventive concept. Referring to FIG. 4, first the PC 20 is connected to the external interface 310 of the apparatus 300, which is a target apparatus, including a plurality of microprocessors whose software is to be upgraded, using a predetermined connecting device operation S410.

Next, each of the first, second, . . . , N^{th} microprocessors 330, 350, . . . , 370 transmits its identification information and information regarding its current software to the PC 20 through the external interface 310 operation S420. The transmission of the identification information through the external interface 310 to the PC 20 can be performed sequentially according to a predetermined order with respect to the microprocessors 330, 350, . . . , 370. For example, the first, second, . . . , N^{th} microprocessors 330, 350, . . . , 370 can sequentially transmit their identification information and information regarding their current software to the PC 20 through the external interface 310.

A manager, located at the PC end, which upgrades the software of the apparatus 300 using the PC 20, can be used to select one of the first, second, . . . , N^{th} microprocessors 330, 350, . . . , 370 as the object to be upgraded operation S430. The identification information of the selected microprocessor is then transmitted to the first, second, . . . , N^{th} microprocessors 330, 350, . . . , 370 via the external interface 310 operation S440 from the PC 20. The particular microprocessor of the first, second, and N^{th} microprocessors 330, 350, and 370 that has the identification information (i.e., the microprocessor selected by the manager) is then designated a host microprocessor, which prepares to communicate with the PC 20 (upgrade device) operation S450. The rest of the microprocessors are then designated as slave microprocessors according to a control of the host microprocessor, and are thus set in a standby mode (operation S460).

The microprocessor temporarily selected as the host microprocessor then upgrades the software therein by communicating with the PC 20 (operation S470). When the identification information of another microprocessor is newly input from the PC 20 (operation S480) after the software of the previously selected host microprocessor is upgraded, operations S430 through S470 are repeated to upgrade software of the microprocessor having the newly input identification information. Accordingly, in this embodiment, one of the microprocessors at a time which is chosen to be upgraded is selected as the host microprocessor, while the other microprocessors are set into a slave mode, and then the same operations are repeated when another microprocessor is chosen to be upgraded.

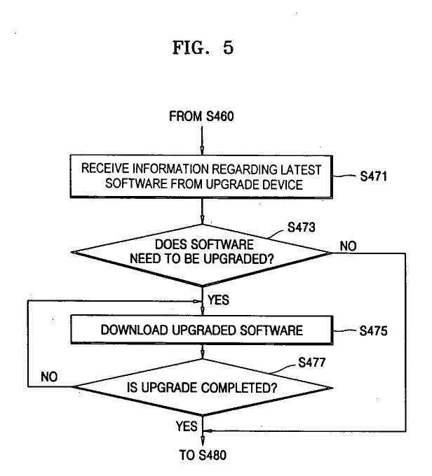

FIG. 5 is a flow chart illustrating operation S470 of FIG. 4 in more detail. An example in which the second microprocessor 350 is the host microprocessor, and the first, . . . , N^{th} microprocessors 330, . . . , 370 are slave microprocessors, as illustrated in FIG. 3, will be described.

The second microprocessor 350, which, in the embodiment of FIG. 3 is illustrated as the host microprocessor, receives information regarding the latest software by request from the PC 20 (operation S471). The information regarding the latest software includes identification information of software and/or information regarding a software version.

The second microprocessor 350 compares the received information regarding the latest software with information regarding its current software stored in an internal memory (not shown), and determines whether the software needs to be updated (operation S473). Information regarding the latest software version and information regarding the current software can be compared to determine whether the software needs to be updated, but the method illustrated in FIG. 5 is not limited thereto.

If the software needs to be updated, the second microprocessor 350 requests a download of the latest software from the PC 20, and downloads the latest software (operation S475). The second microprocessor 350 determines whether upgrading of the software is completed (operation S477). If the upgrading process is not completed successfully, the second microprocessor 350 again requests a download of the latest software from the PC 20, and repeats downloading the latest software.

According to various embodiments of the present general inventive concept described above, the hardware structure of an electronic device having a plurality of microprocessors can be simplified and manufacturing costs can be reduced since only a single external interface is required to be mounted in the electronic device to upgrade software for each of plural microprocessors. Furthermore, an upgrading process of the hardware of the electronic device is simplified, thereby reducing the time consumed for upgrading the software, and reducing errors that are caused during the upgrading process.

For example, using unique identification information for each of the plurality of microprocessors reduces the error of selecting the wrong microprocessor to be upgraded regardless of whether the electronic device has more than one microprocessor of the same type.

Additionally, reducing the number of external interfaces through which a plurality of microprocessors can communicate with an upgrade device simplifies the hardware structure of the upgrade device, thereby reducing errors in connecting the upgrade device with the incorrect external interface and accordingly with an incorrect microprocessor.

The general inventive concept can also be embodied as computer readable codes on a computer readable recording medium. The computer readable recording medium can be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus that upgrades software by communicating with an upgrade device, the apparatus comprising:
an external interface which communicates with the upgrade device; and
a plurality of microprocessors, each storing identification information and information regarding current software therein, wherein each of the microprocessors is capable of transmitting the identification information and the information regarding the current software therein to the upgrade device via the external interface, and
one of the microprocessors among the plurality of microprocessors that has identification information corresponding to identification information received from the upgrade device is determined to be the microprocessor to be upgraded, and prepares to communicate with the upgrade device through the external interface while the rest of the microprocessors are set in a standby mode, and then the microprocessor to be upgraded upgrades the current software therein by communicating the microprocessor to be upgraded with the upgrade device.

2. The apparatus of claim 1, wherein, when the upgrading of the microprocessor to be upgraded is completed, a microprocessor that has identification information corresponding to newly received identification information from the upgrade device becomes designated as the microprocessor to be upgraded and is then prepared to communicate with the upgrade device while the rest of the microprocessors are placed in a standby, and then the microprocessor that is to be newly upgraded upgrades the current software therein by communicating with the upgrade device.

3. The apparatus of claim 1, wherein the rest of the microprocessors are set in the standby mode through control of the microprocessor to be upgraded.

4. The apparatus of claim 1, wherein the microprocessors sequentially communicate their identification information and software information with the upgrade device.

5. The apparatus of claim 1, wherein the microprocessor to be upgraded requests software information from the upgrading device.

6. The apparatus of claim 1, wherein the microprocessor to be upgraded requests software version information from the upgrading device.

7. The apparatus of claim 1, wherein the microprocessor to be upgraded requests the software from the upgrading device.

8. The apparatus of claim 1, wherein the microprocessor to be upgraded compares information regarding upgraded software received from the upgrade device with the information regarding the current software therein, and determines whether to upgrade the current software therein based on the comparison.

9. The apparatus of claim 1, wherein the microprocessor to be upgraded compares information regarding a version of the upgraded software received from the upgrade device with information regarding a version of the current software therein, and determines whether to upgrade the current software therein based on the comparison.

10. The apparatus of claim 1, wherein if the downloading of the new software from the upgrade device fails, the microprocessor automatically requests the new software again.

11. A method of upgrading software for a plurality of microprocessors associated with an electronic device, the method comprising:
transmitting from the electronic device respective identification information and information regarding current software of each of the plurality of microprocessors to an upgrade device which is connected externally to the electronic device;
receiving at the electronic device identification information of a microprocessor to be upgraded at the electronic device from the upgrade device;
preparing the microprocessor to be upgraded for communication with the upgrade device while setting the rest of the microprocessors in a standby mode; and
upgrading software of the microprocessor to be upgraded by communicating the electronic device with the upgrade device.

12. The method of claim 11, wherein when the upgrading of the software of the microprocessor to be upgraded is completed, the receiving of the identification information of the microprocessor to be upgraded from the upgrade device through the upgrading of the software is repeated.

13. The method of claim 11, wherein the rest of the microprocessors are set in the standby mode through control of the microprocessor to be upgraded.

14. The method of claim 11, wherein, during the upgrading of the software, it is determined whether to upgrade the current software by comparing information regarding upgraded software received from the upgrade device with information regarding the current software.

15. The method of claim 14, wherein in the upgrading of the software, a determination is made whether to upgrade the current software by comparing information regarding a version of the upgraded software received from the upgrade device with information regarding a version of the current software.

16. A computer readable recoding medium on which a computer program to perform a method of upgrading software for a plurality of microprocessors included in an electronic device is recorded, the method comprising:
transmitting from the electronic device respective identification information and information regarding current software of each of the plurality of microprocessors to an upgrade device which is connected externally to the electronic device;
receiving at the electronic device identification information of a microprocessor to be upgraded from the upgrade device;
preparing the microprocessor to be upgraded for communication with the upgrade device while setting the rest of the microprocessors in a standby mode; and
upgrading software of the microprocessor to be upgraded by communicating the electronic device with the upgrade device.

17. A method of upgrading software of a plurality of microprocessors within an electronic apparatus, the method comprising:
determining identification information and current software information of each of the plurality of microprocessors through a common external interface of the electronic apparatus;
sending information related to the identification information of the microprocessor to be upgraded through the common external interface to the electronic apparatus to control an operation mode of each of the microprocessors; and
upgrading software of the microprocessor to be upgraded.

18. The method according to claim 17, wherein the upgrading software of the microprocessor includes upgrading each of the microprocessors sequentially, and while one of the microprocessors is being upgraded, the other microprocessors are placed in a standby mode.

19. The method according to claim 17, wherein the information sent includes information that instructs one of the microprocessors to be a host microprocessor while the remaining microprocessors become slave microprocessors to the host.

20. An electronic apparatus that communicates externally to receive software upgrades, comprising:
a plurality of microprocessors each containing software therein and each storing identification information and information regarding a current status of the software contained therein, the microprocessors each being capable of transmitting at least one of the identification information and the information regarding the current status of the software contained therein externally; and
a common external interface to permit communication between the microprocessors and an external device that supplies software upgrades.

21. The electronic apparatus according to claim 20, wherein the plurality of microprocessors determine which one thereof will act as a host microprocessor based on information received from an external device communicated therewith in response to the transmission of the at least one of the identification information and the information regarding the current status of the software contained in each of the microprocessors.

22. The electronic apparatus according to claim 21, wherein the microprocessor determined to act as the host controls the remaining microprocessors to be set as slave microprocessors.

23. The electronic apparatus according to claim 20, wherein information received from the external device includes information on the latest software, and each microprocessor compares the received information with information regarding the current software therein, and determines whether to update the current software therein.

24. The electronic apparatus according to claim 20, wherein each of the microprocessors transmits the at least one of the identification information and the information regarding the current status of the software contained therein to an external device through the common external interface sequentially, according to a predetermined order.

25. The electronic apparatus according to claim 24, wherein the plurality of microprocessors determine which one thereof will act as a host microprocessor based on information received from an external device communicated therewith in response to the sequential transmission of the at least one of the identification information and the information regarding the current status of the software contained in each of the microprocessors.

26. A method of upgrading software for a plurality of microprocessors associated with an electronic device, the method comprising:
transmitting identification information and information regarding current software associated with each of the plurality of microprocessors to a software upgrade source through a common external interface;
receiving a specific signal through the common external interface of the electronic device from the software upgrade source instructing a specific microprocessor of the plurality of microprocessors to prepare for a software upgrade and to control the remaining microprocessors to be in a controllable state, the specific signal containing information based on the transmitted identification information and information regarding current software of each of the plurality of microprocessors; and
upgrading the software of the specific microprocessor.

27. The method according to claim 26, further comprising sequentially upgrading the software of the remaining microprocessors in a predetermined order.

28. A computer readable recoding medium on which a computer program to perform a method of upgrading software for a plurality of microprocessors included in an electronic device is recorded, the method comprising:
transmitting identification information and information regarding current software associated with each of the plurality of microprocessors to a software upgrade source through a common external interface;
receiving a specific signal through the common external interface of the electronic device from the software upgrade source instructing a specific microprocessor of the plurality of microprocessors to prepare for a software upgrade and to control the remaining microprocessors to be in a controllable state, the specific signal containing information based on the transmitted identification information and information regarding current software of each of the plurality of microprocessors; and
upgrading the software of the specific microprocessor.
